(19) United States
(12) Patent Application Publication
(10) Pub. No.: US 2008/0320505 A1
(43) Pub. Date: Dec. 25, 2008

(54) OPTICAL DISC DRIVE

(75) Inventors: Chin-Fa Tu, Taipei (TW); Chi-Hwa Ho, Taipei (TW); Tsung-Lin Wu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/103,684

(22) Filed: Apr. 15, 2008

(30) Foreign Application Priority Data
Jun. 22, 2007 (TW) 96122441

(51) Int. Cl. G11B 17/04

(52) U.S. Cl. 720/619

(57) ABSTRACT

For the optical disc drive in the invention, the holder, the gear set and the transmission part and other components have mechanical interacting relationship, and therefore, when the power of the optical disc drive is cut off, the optical disc still can be ejected from the casing by the mechanical interaction of the components. An optical disc drive including a casing, a holder, a motor, a first and second gear sets, and a transmission part is provided. The holder which can move between a first and second position is disposed in the casing. When the holder moves to the second position, the second gear set is away from the first gear set at a distance, and the transmission part drives the disc to eject from the casing by the external force.

### CROSS-REFERENCE TO RELATED APPLICATION

This application claims the priority benefit of Taiwan application serial no. 96122441, filed on Jun. 22, 2007. The entirety the above-mentioned patent application is hereby incorporated by reference herein and made a part of specification.

### BACKGROUND OF THE INVENTION

1. Field of the Invention

The invention relates to an optical disc drive and, more particularly, to an optical disc drive which can make an optical disc ejected when the power is cut off.

2. Description of the Related Art

Since the development of the computer technology has been mature, the quantity of data which needs to be processed by the computer has been greatly increased. The maturer the development of the computer is, the more the kinds of data which needs to be processed are, and the larger the capacity which is used to store is. Since an optical disc has advantages of low price, convenient to carry, large storage capacity, easy to preserve, long preserving period and uneasy to be damaged and so on, the optical disc has gradually displaced the conventional magnetic storage medium nowadays and becomes an essential optical storage medium of modern people. With the wide usage of the optical disc, the optical disc drive for reading the data of the optical disc has also been the essential electronic product in the life.

As for the moving mode by which the optical disc is putted into the optical disc drive, there are two common kinds, tray-type optical disc drive and suction-type optical disc drive. Taking the suction-type optical disc drive as an example, an optical disc in a suction-type optical drive on the market nowadays can be successfully ejected only by software or pressing an electronic key. That is, a suction-type optical drive does not have the function of ejecting an optical disc urgently. Specifically, after an optical disc is putted into an optical disc drive, users cannot make the optical disc ejected from the optical disc drive when the power of the optical disc drive is cut off. As for the users, this kind of optical disc drive does not have usage convenience.

### BRIEF SUMMARY OF THE INVENTION

One objective of the invention is to provide an optical disc drive having usage convenience.

To obtain the above or other objectives, the invention provides an optical disc drive which is suitable to read an optical disc. The optical disc drive includes a casing, a holder, a motor, a first gear set, a second gear set and a transmission part. The holder is provided in the casing, wherein the holder can moves between a first position and a second position, and when the holder is provided at the first position, the holder can be pushed to move to the second position when an external force is applied to a disc ejecting part. Both the motor and the first gear set are provided on the holder, and along with the holder moves, the motor drives the first gear set to rotate. The second gear set is provided in the casing and beside the first gear set, and the second gear set can be engaged with the first gear set. The transmission part is provided at a first side of the casing, and a first end of the transmission part contacts with the second gear set. When the holder is provided at the first position, the second gear set is engaged with the first gear set. When the holder moves to the second position, the second gear set is away from the first gear set at a distance. When the transmission part drives a rocker of the optical disc drive, the optical disc can be ejected from the casing.

In one embodiment of the invention, the holder is pivotally or slidingly provided at the casing.

In one embodiment of the invention, the first gear set includes a worm and a worm wheel, wherein the worm is connected to the motor, and the worm wheel is engaged with the worm.

In one embodiment of the invention, the second gear set includes a second gear and a third gear, wherein the second gear is provided beside the first gear set and engaged with the first gear set, and the third gear is provided beside the second gear and contacts with the transmission part.

In one embodiment of the invention, the first end of the transmission part is a rack which is engaged with the second gear set.

In one embodiment of the invention, the casing further includes a disc ejecting part pivotally provided at the first side of the casing, and a second end of the disc ejecting part is suitable to contact with the holder.

In one embodiment of the invention, the casing further includes a button or a disc ejecting hole corresponding to the disc ejecting part.

In one embodiment of the invention, a disc ejecting needle can be used to pass through the disc ejecting hole and apply an external force to the disc ejecting part, and then the disc ejecting part pushes the holder to move to the second position and makes the second gear set be away from the first gear set at a distance (namely tooth separation), so that the restriction between the gears is relieved, and the disc is ejected.

In one embodiment of the invention, the transmission part moves to a fourth position from a third position to make the optical disc ejected from the casing.

In one embodiment of the invention, the optical disc drive further includes a rocker provided at a second side of the casing and contacting with a second side of the transmission part, wherein the transmission part drives the rocker to move between a fifth position and a sixth position to make the optical disc ejected from the casing.

In one embodiment of the invention, the second end of the transmission part has a guide slot, and a fourth end of the rocker is provided in the guide slot to make the transmission part drive the rocker to move between the fifth position and the sixth position via the guide slot.

In one embodiment of the invention, the optical disc drive further includes a blocking part pivotally provided at the casing and between the rocker and transmission part, wherein the blocking part is used to restrict the moving distance of the optical disc after the optical disc enters the casing, and the blocking part has a positioning effect.

In one embodiment of the invention, the rocker drives the blocking part to move between a seventh position and a eighth position.

In one embodiment of the invention, the optical disc driver further includes a recovering part provided at the casing and connected to the holder.

In one embodiment of the invention, the recovering part is a spring.

For the optical disc drive in the invention, the holder, the gear set and the transmission part and other components have interacting relationships, and therefore, when the power of the optical disc drive is cut off, the optical disc still can be ejected from the casing by the mechanical interaction of the components, which is very convenient for users to use.

These and other features, aspects, and advantages of the present invention will become better understood with regard to the following description, appended claims, and accompanying drawings.

### BRIEF DESCRIPTION OF THE DRAWINGS

FIG. 1 is a top view showing the optical disc drive in the first embodiment of the invention.

FIG. 2 is a partial enlarged diagram showing the optical disc drive in FIG. 1.

FIG. 3 is a three-dimensional schematic diagram showing the optical disc drive in FIG. 1.

FIG. 4 is a perspective diagram showing the optical disc provided in the optical disc drive.

FIG. 5 is a three-dimensional schematic diagram of FIG. 4.

FIG. 6 is a three-dimensional schematic diagram showing the optical disc drive in the second embodiment of the invention.

FIG. 7 is a schematic diagram showing the components of the optical disc drive shown in FIG. 6 after the optical disc is ejected from the optical disc drive.

### DETAILED DESCRIPTION OF THE EMBODIMENTS

### First Embodiment

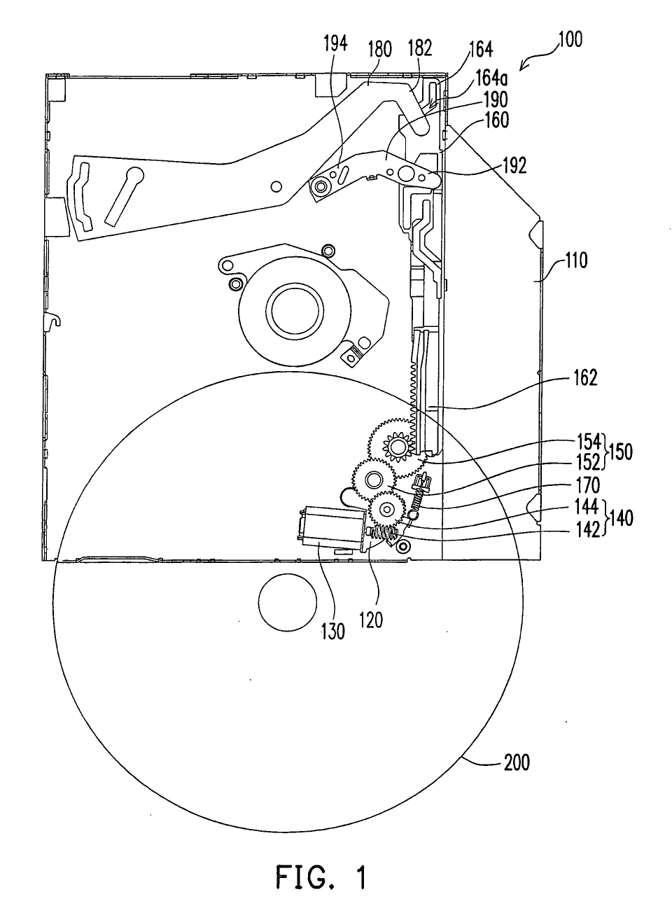

FIG. 1 is a top view showing an optical disc drive of the first embodiment of the invention. Please refer to FIG. 1. The optical disc drive 100 is suitable to read an optical disc 200. The optical disc drive 100 includes a casing 110, a holder 120, a motor 130, a first gear set 140, a second gear set 150 and a transmission part 160.

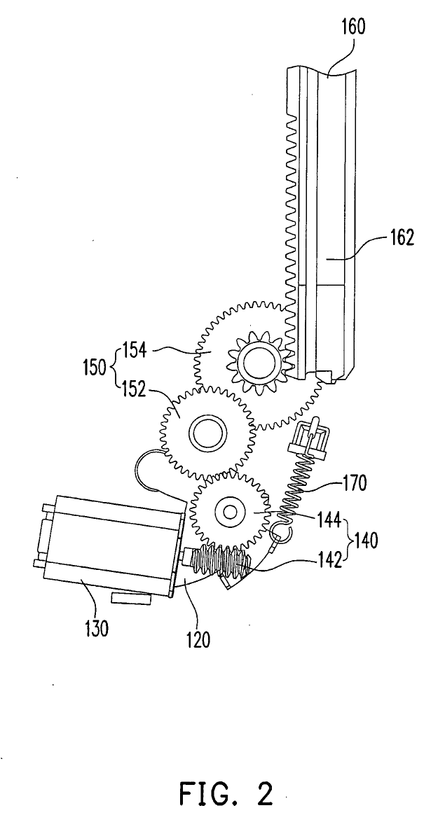

FIG. 2 is a partial enlarged schematic diagram showing the optical disc drive shown in FIG. 1. To make the spirit of the invention more understandable, some components of the optical disc drive 100 are simplified in FIG. 2, and only the holder 120, the motor 130, the first and second gear sets 140 and 150 and the transmission part 160 are shown.

As shown in FIG. 1 and FIG. 2, the motor 130 and the first gear set 140 are both provided on the holder 120 and can move with the holder 120, wherein the motor 130 can drive the first gear set 140 to rotate. Specifically, the first gear set 140 includes a worm 142 and a worm wheel 144, wherein the worm 142 is connected to the motor 130, and the worm wheel 144 is engaged with the worm 142. When the motor 130 acts, it drives the worm 142 to rotate, and the worm wheel 144 engaged with the worm 142 is driven by the worm 142 and rotates.

The second gear set 150 is provided in the casing 110 and beside the first gear set 140, and the second gear set 150 can be engaged with the first gear set 140. In the embodiment, the second gear set 150 includes a second gear 152 and a third gear 154. The second gear 152 is provide beside the first gear set 140 and can be engaged with the worm wheel 144 of the first gear set 140, and the third gear 154 can be engaged with the second gear 152.

The transmission part 160 is provided at the first side of the casing 110, and a first end 162 of the transmission part 160 contacts with the second gear set 150. In the embodiment, the first end 162 of the transmission part 160 is a rack, and the third gear 154 is engaged with the transmission part 160 and the second gear 152.

As shown in FIG. 1 and FIG. 2, the optical disc drive 100 further includes a recovering part 170 provided at the casing 110 and connected to the holder 120. In the embodiment, the recovering part 170 is a spring, and therefore, when the optical disc 200 is ejected from the optical disc drive 100, the recovering part 170 can make the holder 120 return to the first position from the second position by its own elastic force.

Furthermore, the optical disc drive 100 further includes a rocker pivotally provided at the casing 110, and the rocker 180 is provided at a second side in the casing 110. In the embodiment, the rocker 180 contacts with a second end 164 of the transmission part 160, wherein the second end 164 of the transmission part 160 can have at least a guide slot 164a, and the end 182 of the rocker 180 which contacts with the second end 164 has at least a protrusion (not shown) provided in the guide slot 164a to make the transmission part 160 drive the rocker 180 to rotate when the transmission part 160 moves.

In addition, to prevent the optical disc 200 from being scratched and knocking against the casing 110 after the optical disc 200 enters the optical disc drive 100, the optical disc drive 100 further includes a blocking part 190 pivotally connected to the casing 110, wherein the blocking part 190 is provided between the rocker 180 and the transmission part 160. In the embodiment, a protrusion also can be provided at the first end 192 of the blocking part 190, and the second end 194 of the blocking part 190 is suitable to limit the moving distance of the optical disc 200 in the optical disc drive 100. After the optical disc 200 enters the optical disc drive 100, the optical disc 200 pushes the second end 194 of the blocking part 190, and the first end 192 of the blocking part 190 is against the edge of the transmission part 160 to conduct the moving distance of the optical disc 200 in the optical disc drive 100 and prevent the optical disc 200 from being damaged because of the collision with the casing 110.

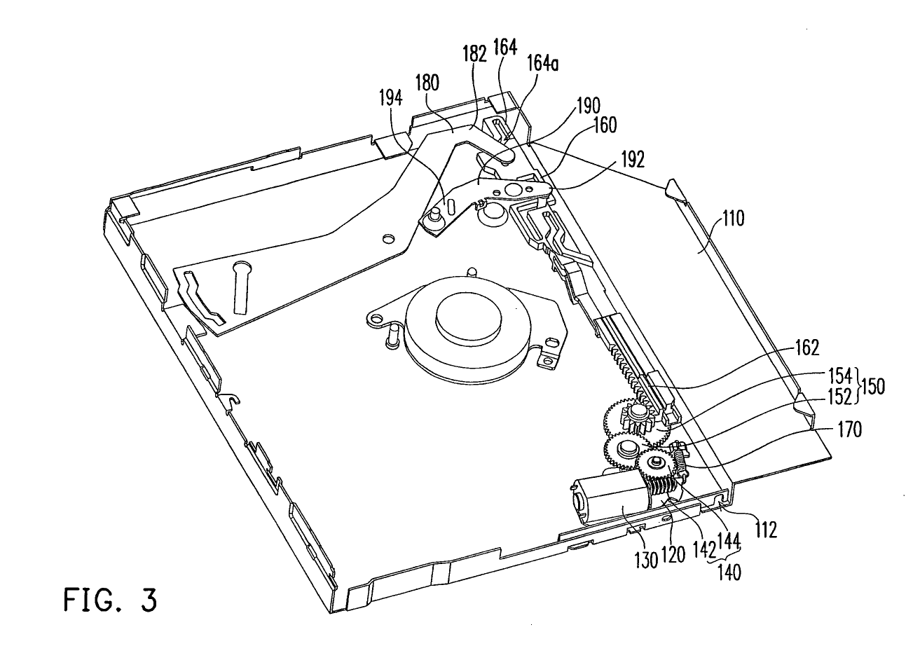

FIG. 3 is a three-dimensional schematic diagram showing the optical disc drive shown in FIG. 1. When the optical disc 200 does not enter the optical disc 100, the holder 120 is provided at the first position, and the worm wheel 144 of the first gear set 140 is engaged with the second gear of the second gear set 150, and the transmission part 160 is provided at the third position and away from the disc ejecting hole 112. In brief, the worm wheel 144 is engaged with the second gear 152. If a user wants to make the optical disc 200 read, when he pushes the optical disc 200 into the casing 110, the optical disc drive 100 can make the optical disc 200 sucked into the casing 110 automatically by the photoelectric sensing element and (or) the mechanical interaction among the components.

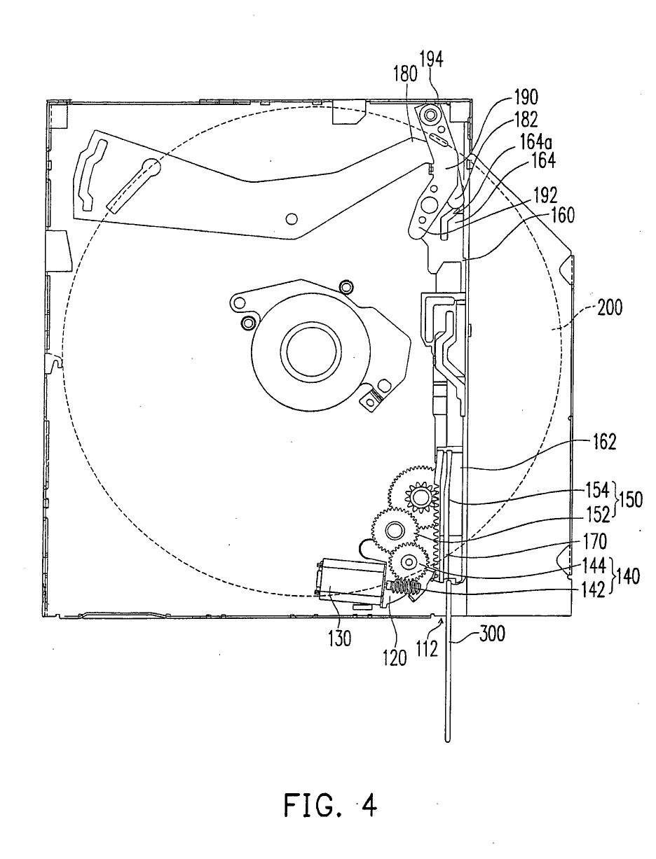

FIG. 4 is a perspective view showing the optical disc in the optical disc drive. After the optical disc 200 enters the optical disc drive 100, the holder 120 is provided on the first position, and at that moment, the worm wheel 144 of the first gear set 140 is engaged with the second gear of the second gear set 150, and the transmission part 160 is provided at the fourth position and close to the disc ejecting hole 112 relatively. At the same time, the motor 130 works, and therefore, the worm 142 is driven by the motor 130 and begins to rotate, and then the worm wheel 144, the second gear 152 and the third gear 154 are driven in sequence. The rotation of the third gear 154 drives the transmission part 160 to move to the fourth position from the third position in a direction toward the disc ejecting hole 112, so that the first end 162 of the transmission part 160 is close to the disc ejecting hole 112 relatively. The rocker 180 moves to the sixth position from the fifth position with the conduction of the guide slot 164a of the transmission part 160. In addition, the blocking part 190 rotates with the conduction of the edge of the transmission part 160 along with the optical disc 160 contacts with the second end 194 and the first end 192 to limit the moving distance of the optical disc 200 in the optical disc drive 100 to conduct the optical disc 200 to position.

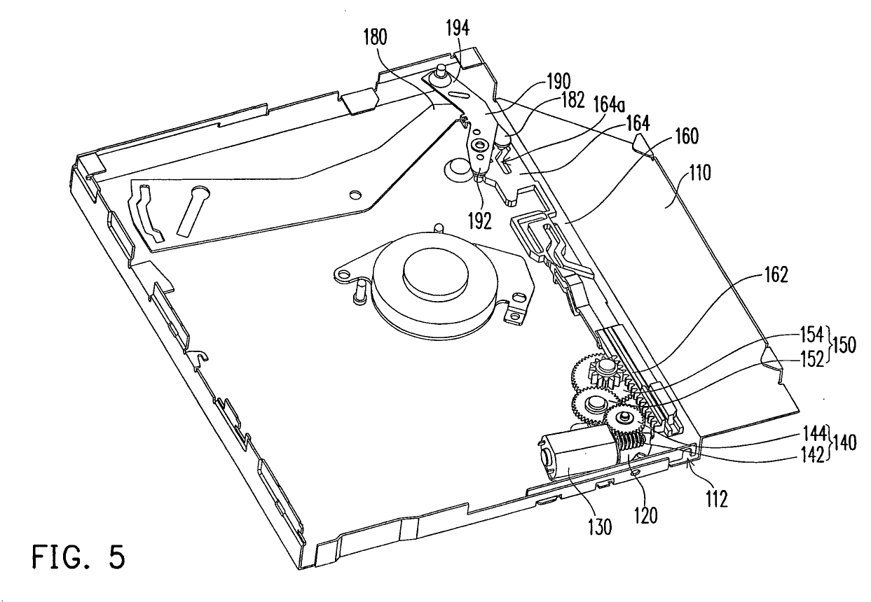

FIG. 5 is a three-dimensional schematic diagram of FIG. 4. Please refer to FIG. 4 and FIG. 5. When the optical disc 200 is completely putted into the optical disc drive 100, the holder 120 is provided at the first position, and at that moment, the second gear set 150 is engaged with the first gear set 140. That is, the worm wheel 144 is engaged with the second gear 152. In addition, the first end 162 of the transmission part 160 is close to the disc ejecting hole 112 relatively. At that moment, user can make the data stored in the optical disc 200 read by software or other devices.

When the optical disc drive 100 is powered on, users can make the optical disc 200 ejected from the optical disc drive 100 by software or manually pressing the disc ejecting key (not shown) provided at the casing 110. However, when users cut off the power of the optical disc drive 100, or the power of the optical disc drive is cut off urgently, users cannot use the software to make the optical disc 200 ejected from the optical disc drive 100.

### Second Embodiment

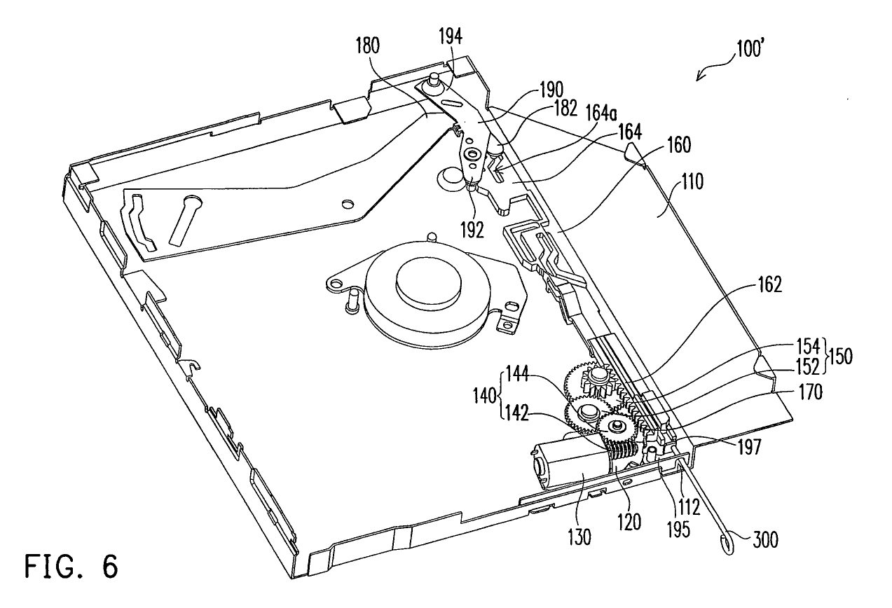

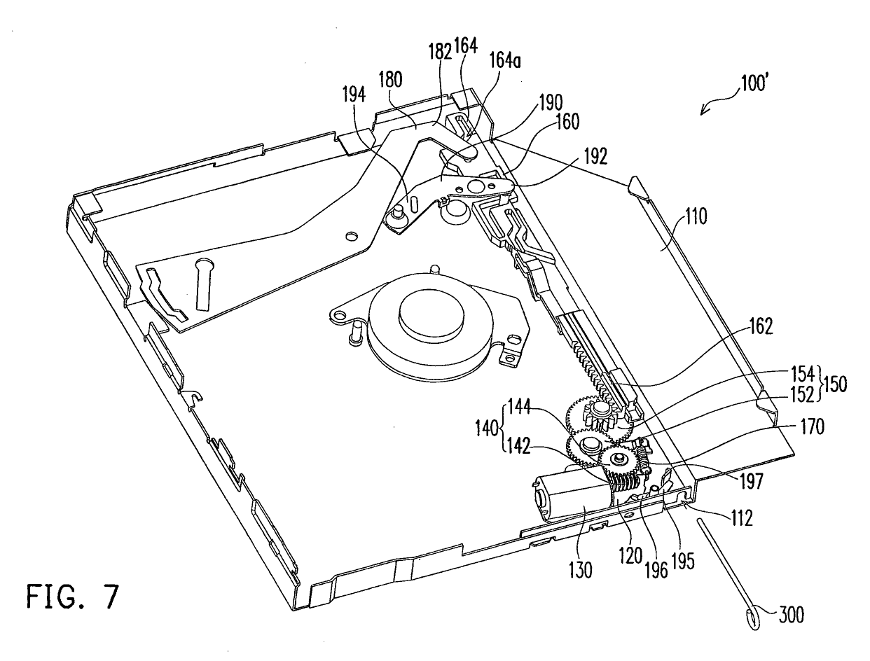

In the embodiment, a method for making the optical disc 200 ejected from the optical disc drive 100′ when the optical disc drive 100′ is powered off or the power of the optical disc drive 100′ is cut off urgently is provided. FIG. 6 and FIG. 7 are three-dimensional schematic diagrams showing the optical disc drive of the second embodiment of the invention, wherein FIG. 6 is schematic diagram showing the components of the optical disc drive when the optical disc is putted in the optical disc drive. This embodiment is about same with the first embodiment, and the same element reference numbers denote for the same components in the first embodiment. The difference between the first embodiment and the second embodiment is described in detail hereinbelow, and the same portion is not described for concise purpose.

Please refer to FIG. 6 and FIG. 7. The optical disc drive 100′ further includes a disc ejecting part 195 pivotally provided at the first side of the casing 110′, and the first end 196 of the disc ejecting part 195 contacts with the holder 120, while the second end 197 is close to the disc ejecting hole 112 relatively. In this embodiment, the disc ejecting hole 112 of the casing 110′ is provided correspondingly to the disc ejecting part 195, and the disc ejecting needle makes the disc ejecting part 195 rotate and drives the holder 120 to move to make the second gear set 150 separate from the first gear set 140 from an engaging state. That is, the worm wheel 144 is away from the second gear 152 at a distance (tooth separation), and the disc ejecting needle 300 is continuously against the first section 162 of the transmission part 160 which drives the rocker 180 interacting with the other end 182 to make the optical disc 200 ejected from the optical disc drive 100′. Therefore, when the power of the optical disc drive 100′ is cut off, users still can make the optical disc 200 ejected from the optical disc drive 100′ via the disc ejecting hole 112.

FIG. 7 is a schematic diagram showing the optical disc ejected from the optical disc drive. Please refer to FIG. 6 and FIG. 7 simultaneously. The disc ejecting needle 300 is used to push the disc ejecting part 195 to make the second end 197 of the disc ejecting part 195 move away from the disc ejecting hole 112 relatively, and the first end 196 moves close to the disc ejecting hole 112 relatively, and the elastic force of the recovering part 170 makes the holder 120 return to the first position from the second position. The first gear set 140 and the second gear set 150 are engaged with each other again from a separating state by the elastic force of the recovering part 170, wherein the recovering part of the embodiment is a compressed spring.

Although the first gear set in the first and the second embodiment is composed of the worm and the worm wheel, and the second gear set is composed of two gears, people who are familiar with the skills can change the quality of gears according to the actual need or make the transmission part move in other driving manners. In addition, although when the optical disc is ejected from the optical disc drive, the transmission part moves to the position which is far away from the disc ejecting hole from the position which is close to the disc ejecting hole relatively, people who are familiar with the skills can change the moving direction of the transmission part within the spirit of the invention. Certainly, as long as the spirit of the invention is not violated, people who are familiar with the skills can also change the working manner of the components such as the holder, the blocking part, the disc ejecting part and the rocker and so on, and then the effect of the main objective of the invention can also be obtained.

To sum up, the optical disc drive of the invention utilizes the interaction among the components such as the movable holder, the first and second gear set, the transmission part, the rocker and the blocking part and so on to make the optical disc ejected from the optical disc drive by the mechanical interaction when the power of the optical disc drive is cut off. Therefore, the optical disc in the optical disc drive in the invention can be ejected when the power is on or off, which is very convenient for users.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An optical disc drive which is suitable to read an optical disc, the optical disc drive comprising:
a casing;
a holder providing in the casing, and the holder moves between a first position and a second position;
a motor providing in the holder and move with the holder;
a first gear set providing in the holder, wherein the motor driving the first gear set to rotate;
a second gear set providing in the casing next to the first gear set; and
a transmission part providing at a first side of the casing, wherein a first end of the transmission part contacts with the second gear set,
when the holder moves to the first position, the second gear set is engaged with the first gear set; when the holder moves to the second position, the second gear set is away from the first gear set in a distance, and when the second gear set drives the transmission part, the optical disc ejects from the casing.

2. The optical disc drive according to claim 1, wherein the holder is pivotally or slidingly provided in the casing.

3. The optical disc drive according to claim 1, wherein the first gear set comprises a worm connected to the motor and a worm wheel engaged with the worm.

4. The optical disc drive according to claim 1, wherein the second gear set comprises a second gear and a third gear, the second gear is provided next to the first gear set and is engaged with the first gear set, the third gear is provided next to the second gear and contacts with the transmission part.

5. The optical disc drive according to claim 1, wherein the first end of the transmission part is a rack engaged with the second gear set.

6. The optical disc drive according to claim 1, wherein the casing further comprises a disc ejecting part pivotally provided at the first side of the casing, and a second end of the disc ejecting part is suitable to contact with the holder.

7. The optical disc drive according to claim 6, wherein the casing further comprises a button or a disc ejecting hole which is corresponding to the disc ejecting part.

8. The optical disc drive according to claim 7, wherein a disc ejecting needle passes through the disc ejecting hole and applies an external force to the disc ejecting part, and the disc ejecting part pushes the holder to eject the optical disc from the casing.

9. The optical disc drive according to claim 1, wherein the transmission part moves to a fourth position from a third position to make the optical disc ejected from the casing.

10. The optical disc drive according to claim 1, further comprises a rocker provided at a second side of the casing and contacted with a second end of the transmission part, wherein the transmission part drives the rocker to move between the fifth position and a sixth position to eject the optical disc from the casing.

11. The optical disc drive according to claim 10, wherein the second end of the transmission part has a guide slot, and a fourth end of the rocker is provided in the guide slot, so that the transmission part drives the rocker to move between the fifth position and the sixth position via the guide slot.

12. The optical disc drive according to claim 10, further comprises a blocking part pivotally provided at the casing and between the rocker and the transmission part, wherein the blocking part is suitable to limit the moving distance of the optical disc after the optical disc enters the casing.

13. The optical disc drive according to claim 12, wherein the rocker drives the blocking part to move between a seventh position and a eighth position.

14. The optical disc drive according to claim 1, further comprising a recovering part provided at the casing and connected to the holder.

15. The optical disc drive according to claim 14, wherein the recovering part is a spring.
